(19) United States
(12) Patent Application Publication
(10) Pub. No.: US 2015/0006774 A1
(43) Pub. Date: Jan. 1, 2015

(54) SYSTEM AND METHOD FOR CONTROLLING A BUS IN RESPONSE TO AN INDICATION OF BUS CAPACITY IN A PORTABLE COMPUTING DEVICE

(71) Applicant: Qualcomm Incorporated, San Diego, CA (US)

(72) Inventors: SEJOONG LEE, SAN DIEGO, CA (US); STEVEN THOMSON, SAN DIEGO, CA (US); TAUSEEF KAZI, SAN DIEGO, CA (US); SUMEET SETHI, SAN DIEGO, CA (US)

(21) Appl. No.: 13/927,123

(22) Filed: Jun. 26, 2013

(51) Int. Cl. G06F 13/364

(52) U.S. Cl. CPC G06F 13/364
USPC 710/107

(57) ABSTRACT

Systems and methods for real-time control of a bus operating point in a portable computing device (“PCD”) are presented. An indication of an event occurring in a bus interface is used as an indicator of a mismatch between a resource request and a data throughput level that can be supported by the bus. A suitable mechanism for identifying the mismatch provides a cost effective and non-invasive solution that is generally applicable for all usage situations.

### DESCRIPTION OF THE RELATED ART

Portable computing devices (PCDs) are ubiquitous. These devices may include cellular telephones, portable digital assistants (PDAs), portable game consoles, palmtop computers, and other portable electronic devices. In addition to the primary function of these devices, many include peripheral functions. For example, a cellular telephone may include the primary function of enabling and supporting cellular telephone calls and the peripheral functions of a still camera, a video camera, global positioning system (GPS) navigation, web browsing, sending and receiving emails, sending and receiving text messages, push-to-talk capabilities, etc. As the functionality of such a device increases, the computing or processing power required to support such functionality also increases. It is well established that power storage capacity is a limiting factor. Accordingly, attempts to minimize power consumption in PCDs are welcome.

Dynamic Voltage and Frequency Scaling (DVFS) can be used to optimize power consumption. DVFS control methods adjust a clock frequency to sustain a desired throughput. The power savings are proportional to the change in frequency. Alternatively, or in addition to the above-described adjustment in clock frequency, the supply voltage is reduced to a level that will just avoid timing errors at the operating frequency. The power savings are proportional to the square of the voltage reduction.

Identifying conditions that support a change in one or both of the operating voltage and clock frequency while sustaining a desired system performance is not trivial. For PCDs that support cellular telephone calls, as well as the described peripheral functions, conventional power control solutions use a global approach to ensure a desired operator experience.

Thus, there is a need for improved mechanisms for optimizing power consumption in a PCD.

### SUMMARY OF THE DISCLOSURE

Systems and methods are disclosed that enable real-time monitoring of a bus interface and application of the result of the monitoring in a cost-effective control methodology to control power consumption in a portable computing device (“PCD”). A state or condition of a set of signals at the bus interface between a processing resource and the bus is observed for an indication that the bus is incapable of achieving a present demand. A signal generated in response to the indication and a bus clock are used to generate an input to a signal processor. The signal processor generates a control signal that varies when a modified representation of the input exceeds a threshold. The control signal is applied at an input of a controller that generates an adjustment signal. The adjustment signal directs a change in a bus operating point.

One example embodiment is a PCD including a processing resource communicatively coupled to a bus by a bus interface. The PCD further includes a detector, a sampler, a signal processor and a controller. The detector identifies when the bus is incapable of achieving a present demand by generating a rejection signal. The sampler receives the rejection signal and generates a modified signal in accordance with a bus clock. The signal processor receives the modified signal and generates a control signal when the modified and processed signal exceeds a threshold. In turn, the controller generates an appropriate adjustment signal when the modified and processed signal exceeds the threshold. The adjustment signal directs the bus to change a present bus operating point.

Another example embodiment is a method for controlling a bus. The method includes the steps of receiving an event from a bus interface, the event indicating that the bus in incapable of achieving a present demand, forwarding a signal generated in response to the event and a bus clock, receiving the signal at a signal processor arranged to generate a control signal when the signal exceeds a threshold, receiving the control signal at a controller arranged to generate an adjustment signal, and applying the adjustment signal to direct a change in a bus operating point.

Another example embodiment is a non-transitory processor-readable medium having stored therein processor instructions and data that direct the processor to: receive an indication of an event from a bus interface, the event indicating that the bus is incapable of achieving a present demand; sub-sample the indication of the event from the bus interface in accordance with a bus clock to generate a sub-sampled signal; process the sub-sampled signal by detecting an edge of the sub-sampled signal to generate a representation of the sub-sampled signal; apply a low-pass filter to the representation of the sub-sampled signal to generate a filtered representation of the sub-sampled signal; compare the filtered representation of the sub-sampled signal with a first threshold and a second threshold; generate a first control signal when the filtered representation of the sub-sampled signal exceeds a first threshold; generate a second control signal when the filtered representation of the sub-sampled signal is below a second threshold; generate an adjustment signal in response to the first or the second control signal; and communicate the adjustment signal to the bus.

### BRIEF DESCRIPTION OF THE DRAWINGS

In the drawings, like reference numerals refer to like parts throughout the various views unless otherwise indicated. For reference numerals with letter character designations such as “102A” or “102B”, the letter character designations may differentiate two like parts or elements present in the same figure. Letter character designations for reference numerals may be omitted when it is intended that a reference numeral to encompass all parts having the same reference numeral in all figures.

FIG. 1 is a schematic diagram illustrating an example embodiment of a portable computing device (PCD).

FIG. 2 is schematic diagram illustrating an example aspect of the PCD of FIG. 1.

FIG. 3 is a block diagram of a second example aspect of the PCD of FIG. 1.

FIG. 4 is an embodiment of the real-time bus monitoring and control system of FIG. 3.

FIG. 5 is a schematic diagram illustrating an embodiment of the detector and an embodiment of the sampler of FIG. 4.

FIG. 6 is a block diagram illustrating an embodiment of the signal processor of FIG. 4.

FIG. 7 is a signal timing diagram illustrating an embodiment of multiple signals within the real-time bus monitoring and control system of FIG. 4.

FIG. 8 is a simulation illustrating an example intermediate signal in the real-time bus monitoring and control system of FIG. 4.

FIGS. 9A-B are simulations illustrating examples of bus frequency plots for a bus operating in accordance with the real-time bus monitoring and control system of FIG. 4.

FIG. 10 is a flowchart illustrating an example embodiment of a method for controlling a bus in response to a real-time indication of bus capacity in a PCD.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

The term “content” may also include files having executable content, such as: object code, scripts, byte code, markup language files, and patches. In addition, “content” referred to herein, may also include files that are not executable in nature, such as documents that may need to be opened or other data files or data values that need to be accessed.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer-readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

In this description, the term “portable computing device” (“PCD”) is used to describe any device operating on a limited capacity rechargeable power source, such as a battery and/or capacitor. Although PCDs with rechargeable power sources have been in use for decades, technological advances in rechargeable batteries coupled with the advent of third generation (“3G”) and fourth generation (“4G”) wireless technology have enabled numerous PCDs with multiple capabilities. Therefore, a PCD may be a cellular telephone, a satellite telephone, a pager, a PDA, a smartphone, a navigation device, a smartbook or reader, a media player, a combination of the aforementioned devices, a laptop or tablet computer with a wireless connection, among others.

The present systems and methods for controlling a bus in response to an indication that the bus has reached its capacity under present operating conditions applies a feedback signal derived from a bus interface to dynamically modify a bus clock frequency in a system-on-chip (SoC) design in real time. The derived feedback signal tracks a discrepancy or failure of the bus to meet a data demand.

The discrepancy or failure is identified by a rejection event detectable in a bus interface. Such a rejection event indicates an instantaneous mismatch between data traffic injected by a processing subsystem and data traffic that can be adequately processed by the bus. The rejection event is agnostic to the underlying application. Therefore, the rejection event can be identified and used for all use cases of the PCD. A rejection signal responsive to the rejection event can be generated with just a few logic gates, while the bus and the bus interface require no modification.

Furthermore, the generated rejection signal requires only minimal processing to produce a closed loop control system with desired response times. Thus, the present systems and methods provide an economical and readily scalable approach to managing power consumption in a PCD.

In an example embodiment, a PCD includes a processing resource, a bus, a detector, a sampler, a signal processor, and a controller. The processing resource is communicatively coupled to the bus via a bus interface. The detector is responsive to signal conditions in the bus interface. The detector is arranged to identify when the bus in incapable of supporting or achieving a present data demand. Upon identifying such a condition on the bus, the detector generates a rejection signal. The sampler is connected to an output of the detector and receives the rejection signal as well as a bus clock. The sampler is arranged to generate a modified signal in response to the rejection signal and the bus clock. The signal processor is connected to an output of the sampler and is arranged to generate a control signal when the modified signal exceeds a threshold. The controller is connected to an output of the signal processor and is arranged to generate an adjustment signal that directs the bus to change a present operating point.

The detector identifies a present state or operating condition of the bus as defined by a valid address signal asserted by the processing resource and a de-asserted ready signal from the busin the bus interface. The detector can be coupled to receive bus interface signals that connect the bus to a multimedia subsystem, a peripheral subsystem, a modem subsystem, an application subsystem, a memory subsystem, an audio subsystem, a wireless connectivity subsystem, or other subsystems of the PCD.

In an example embodiment, the sampler includes a counter that receives the bus clock and generates an output signal that changes after a select number of bus clock transitions. The select number of bus transitions applied by the sampler can be predetermined or programmable. For example, when the select number of clock signal transitions is 32, the sampler will generate an output signal change responsive to every 32^{nd} clock signal transition and the received rejection signal. As described, the sampler is arranged to down sample or sub-sample the rejection signal. The sub-sampled representation of the rejection signal includes a reduced data rate when compared to the data rate of the rejection signal.

The signal processor receives the sub-sampled rejection signal and a clock signal other than the bus clock and generates a modified representation of the sub-sampled rejection signal. In an example embodiment, the signal processor includes an edge detector, a low-pass filter, a first comparator and a second comparator. The edge detector responds by generating a change in its output voltage when a transition is encountered in the sub-sampled rejection signal. The edge detector output is forwarded to the low-pass filter, which allows signal changes that occur at a rate below the cutoff frequency of the filter to pass through to an output of the filter. At the cutoff frequency, the filter reduces or attenuates the amplitude of the input signal by one-half. Signal transitions that occur at a rate above the cutoff frequency of the filter are further reduced from the output of the filter. Thus, a low-pass filter provides a smoothing function to an input signal by removing or reducing short term changes in the input signal voltage.

When a low-pass filter is implemented in an analog circuit with a resistor and a capacitor the cutoff frequency varies in accordance with the resistance and capacitance values of the resistor and capacitor. In various circuit arrangements switches can be controllably opened or closed to introduce different resistance and capacitance values as desired to control the cutoff frequency.

When a low-pass filter is implemented in a digital circuit, a real-time approximation of an ideal low-pass filter can be realized by truncating and windowing an impulse response. Application of the digital real-time filter requires a delay, which results in a phase shift in the output of the low-pass filter. With a greater desired accuracy of the real-time approximation comes a corresponding increase in delay or phase shift. That is, it takes time to achieve a desired accuracy.

The comparators receive the output of the low-pass filter and also receive respective threshold values. For example, a first comparator receives the sub-sampled and low-pass filtered version of the rejection signal and a first threshold voltage. The first comparator generates a change in its output voltage when the sub-sampled and low-pass filtered signal exceeds the first threshold. Thus, the first threshold is an “up” threshold. In contrast with the first comparator, the second comparator receives a second threshold voltage and generates an opposite change in its output voltage when the sub-sampled and low-pass filtered version of the rejection signal is below the second threshold voltage. Thus, the second threshold is a “down” threshold.

The output signals from the comparators are applied at the controller. The comparator generated signals are respective indicators that direct the controller that a bus operating point change is in order. A bus operating point is defined by bus clock frequency, a bus supply voltage or both. For example, each time the controller receives a change in its input indicating that the “up” threshold has been exceeded, the controller is arranged to increase the frequency of the bus clock. Conversely, each time the controller receives an change in its input indicating that the “down” threshold has been exceeded, the controller is arranged to decrease the frequency of the bus clock. In some embodiments, a bus operating voltage can be adjusted to avoid timing errors at the present bus clock frequency.

Although described with particular reference to operation within a PCD, the described closed-loop feedback control systems and methods are applicable to any larger system with a processor or processing subsystem and a communication bus where it is desirable to conserve power consumption. Stated another way, the detector, signal processor and controller may be provided to controllably adjust a bus clock frequency in a communication bus in a system other than in a portable device.

The detector, sampler, signal processor, and controller and their respective components, are hardware devices that can include any or a combination of the following technologies, which are all well known in the art: discrete electronic components, an integrated circuit, an application-specific integrated circuit having appropriately configured semiconductor devices and resistive elements, etc.

When a PCD or other system is implemented partially in software, the software portion can be used to sample and modify the detected rejection signal to generate one or more control inputs that direct a frequency synthesizer associated with a communication bus to adjust a present bus clock frequency. The software and data used in representing various elements can be stored in a memory and executed by a suitable instruction execution system (microprocessor). The software may comprise an ordered listing of executable instructions for implementing logical functions, and can be embodied in any “processor-readable medium” for use by or in connection with an instruction execution system, apparatus, or device, such as a single or multiple-core processor or processor-containing system. Such systems will generally access the instructions from the instruction execution system, apparatus, or device and execute the instructions.

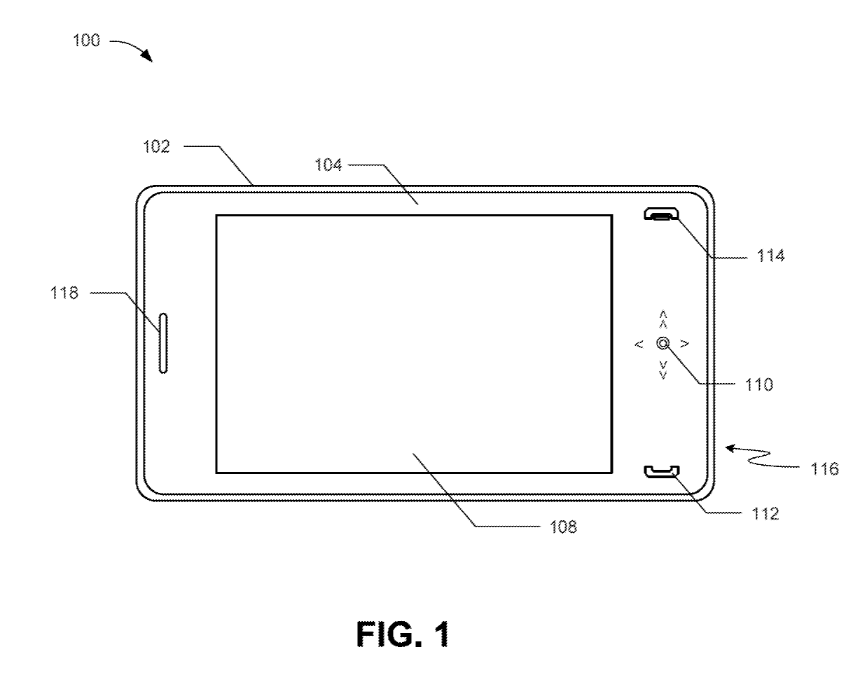

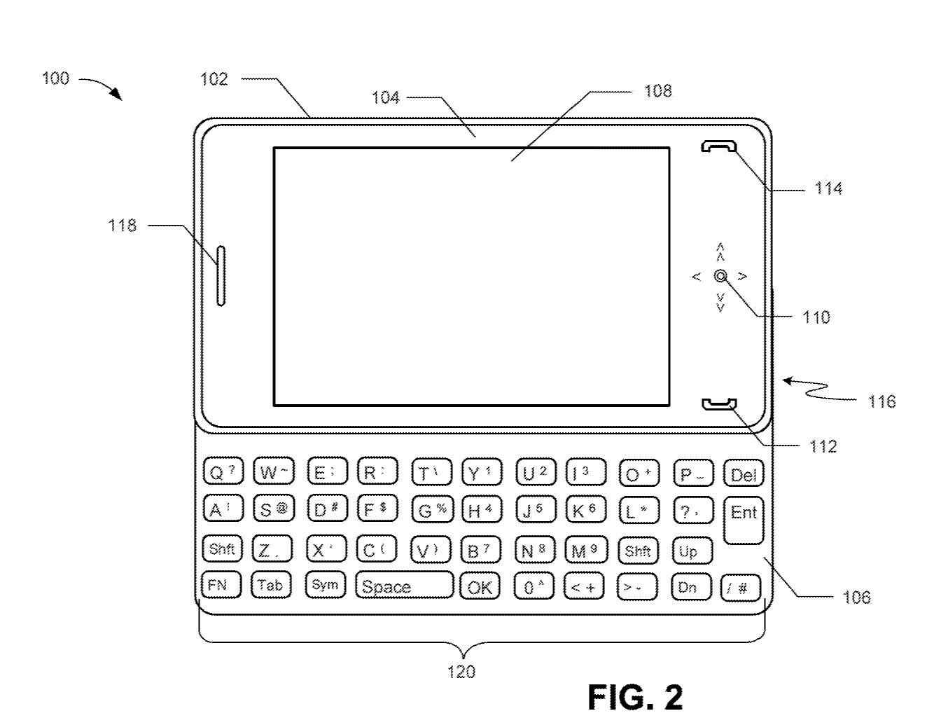

Referring initially to FIG. 1 and FIG. 2, an exemplary portable computing device (PCD) 100 is shown. The PCD 100 includes a housing 102. The housing 102 has an upper housing portion 104 and a lower housing portion 106. FIG. 1 shows that the upper housing portion 104 may include a display 108. In a particular aspect, the display 108 may be a touch screen display. The upper housing portion 104 includes a trackball input device 110. Further, as shown in FIG. 1, the upper housing portion 104 includes a power on button 112 and a power off button 114, a speaker 118 and a microphone 116. In an alternative embodiment (not shown) a single pushbutton may be arranged to enable a power on mode and thereafter a power off mode. Additional pushbutton(s) may be provided to control operation of various subsystems arranged within the housing 102. For example, the PCD 100 may be arranged with a pushbutton (not shown) to answer a phone call communicated to the PCD by a cellular service provider.

In a particular aspect, as depicted in FIG. 2, the upper housing portion 104 is movable relative to the lower housing portion 106. Specifically, the upper housing portion 104 may be slidable relative to the lower housing portion 106. As shown in FIG. 2, the lower housing portion 106 includes a multi-button keyboard 120. In a particular aspect, the multi-button keyboard 120 may be a standard QWERTY keyboard. The multi-button keyboard 120 may be revealed when the upper housing portion 104 is moved relative to the lower housing portion 106.

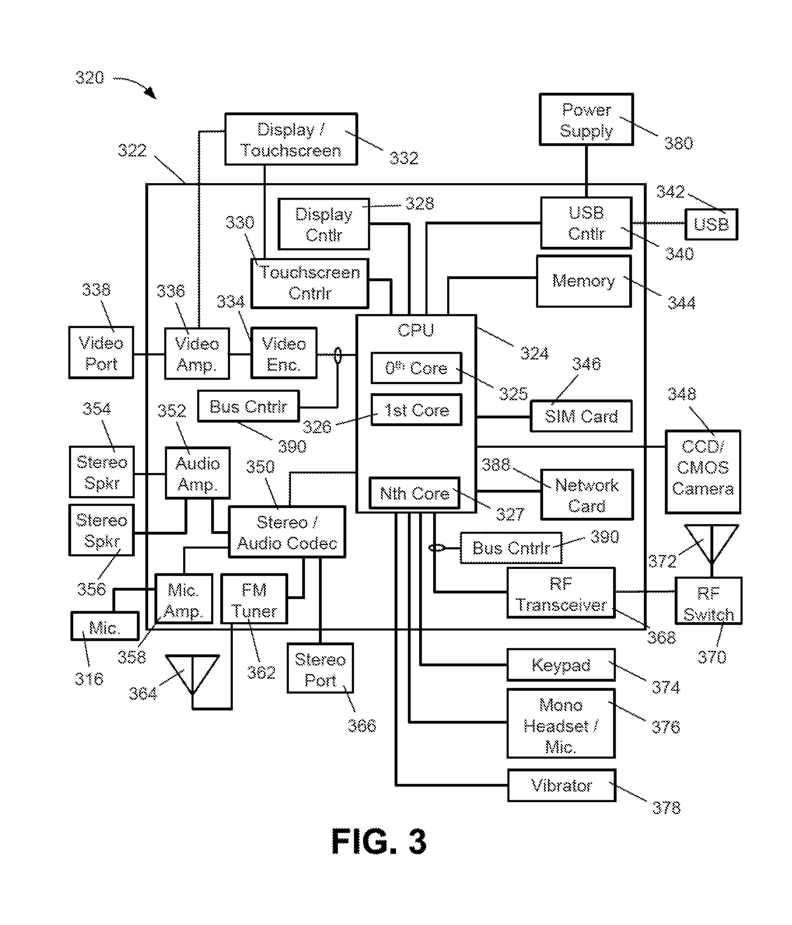

Referring to FIG. 3, an exemplary, non-limiting aspect of a portable computing device (PCD) is shown and is generally designated 320. As shown, the PCD 320 includes an on-chip system 322 that includes a multicore CPU 324. The multicore CPU 324 includes a zero^{th} core 325, a 1^{st} or first core 326, and an N^{th} core 327.

As illustrated in FIG. 3, a display controller 328 and a touch screen controller 330 are coupled to the multicore CPU 324. In turn, display/touchscreen 332, external to the on-chip system 322, is coupled to the display controller 328 and the touch screen controller 330.

FIG. 3 further indicates that a video encoder 334, e.g., a phase alternating line (PAL) encoder, a sequential couleur a memoire (SECAM) encoder, or a national television system(s) committee (NTSC) encoder, is coupled to the multicore CPU 324. Further, a video amplifier 336 is coupled to the video encoder 334 and the display/touchscreen 332. Also, a video port 338 is coupled to the video amplifier 336. As depicted in FIG. 3, a universal serial bus (USB) controller 340 is coupled to the multicore CPU 324. Also, a USB port 342 is coupled to the USB controller 340. A memory 344 and a subscriber identity module (SIM) card 346 may also be coupled to the multicore CPU 324. Further, as shown in FIG. 3, a digital camera 348 may be coupled to the multicore CPU 324. In an exemplary aspect, the digital camera 348 is a charge-coupled device (CCD) camera or a complementary metal-oxide semiconductor (CMOS) camera.

As further illustrated in FIG. 3, a stereo audio CODEC 350 may be coupled to the multicore CPU 324. Moreover, an audio amplifier 352 may be coupled to the stereo audio CODEC 350. In an exemplary aspect, a first stereo speaker 354 and a second stereo speaker 356 are coupled to the audio amplifier 352. FIG. 3 shows that a microphone amplifier 358 may be also coupled to the stereo audio CODEC 350. Additionally, a microphone 316 may be coupled to the microphone amplifier 358. In a particular aspect, a frequency modulation (FM) radio tuner 362 may be coupled to the stereo audio CODEC 350. Also, a FM antenna 364 is coupled to the FM radio tuner 362. Further, a stereo port 366 may be coupled to the stereo audio CODEC 350.

FIG. 3 further indicates that a radio frequency (RF) transceiver 368 is coupled to the multicore CPU 324. An RF switch 370 may be coupled to the RF transceiver 368 and an RF antenna 372. As shown in FIG. 3, a keypad 374 is coupled to the multicore CPU 324. Also, a mono headset with a microphone 376 may be coupled to the multicore CPU 324. Further, a vibrator device 378 may be coupled to the multicore CPU 324. FIG. 3 also shows that a power supply 380 may be coupled to the on-chip system 322 via the USB controller 340. In a particular aspect, the power supply 380 is a direct current (DC) power supply that provides power to the various components of the PCD 320 that require power. Further, in a particular aspect, the power supply is a rechargeable DC battery or a DC power supply that is derived from an alternating current (AC) to DC transformer that is connected to an AC power source.

FIG. 3 further indicates that the PCD 320 may also include a network card 388 that may be used to access a data network, e.g., a local area network, a personal area network, or any other network. The network card 388 may be a Bluetooth network card, a WiFi network card, a personal area network (PAN) card, or any other network card well known in the art. Further, the network card 388 may be incorporated in an integrated circuit. That is, the network card 388 may be a full solution in a chip, and may not be a separate network card 388.

As depicted in FIG. 3, the display/touchscreen 332, the video port 338, the USB port 342, the camera 348, the first stereo speaker 354, the second stereo speaker 356, the microphone 316, the FM antenna 364, the stereo port 366, the RF switch 370, the RF antenna 372, the keypad 374, the mono headset 376, the vibrator 378, and the power supply 380 are external to the on-chip system 322.

RF transceiver 368, which may include one or more modems, may support one or more of global system for mobile communications (“GSM”), code division multiple access (“CDMA”), wideband code division multiple access (“W-CDMA”), time division synchronous code division multiple access (“TDSCDMA”), long term evolution (“LTE”), and variations of LTE such as, but not limited to, FDB/LTE and PDD/LTE wireless protocols.

As further indicated in FIG. 3, two instances of a bus controller 390 are provided. As explained in detail below, the bus controller 390 is responsive to signals in the bus interface that communicatively couple the CPU 324 to components of a wireless subsystem, e.g., the RF transceiver 368, RF switch 370 and antenna 372. A second instance of a bus controller 390 is responsive to signals in the bus interface that communicatively couple the CPU 324 to components of a multimedia subsystem.

In the illustrated embodiment, two instances of a bus controller 390 are depicted. However, it should be understood that any number of similarly configured bus controllers 390 can be arranged to monitor a bus interface arranged in the on-chip system 322. Alternatively, a single bus controller could be configured with inputs arranged to monitor two or more bus interfaces that communicate signals between CPU 324 and various subsystems of the PCD 320 as may be desired.

In a particular aspect, one or more of the method steps described herein may be enabled via a combination of data and processor instructions stored in the memory 344. These instructions may be executed by the multicore CPU 324 in order to perform the methods described herein. Further, the multicore CPU 324, the memory 344 or a combination thereof may serve as a means for executing one or more of the method steps described herein in order to monitor a suitably configured communication busin the PCD 320 in real time and controllably direct a change to one or more operational parameters of the communication bus. For example, when conditions in a monitored communication bus indicate that the bus is incapable of supporting a request for data, a bus clock frequency may be increased in desired steps and rechecked until the bus provides the requested data at the desired rate or the bus clock frequency is at a maximum value.

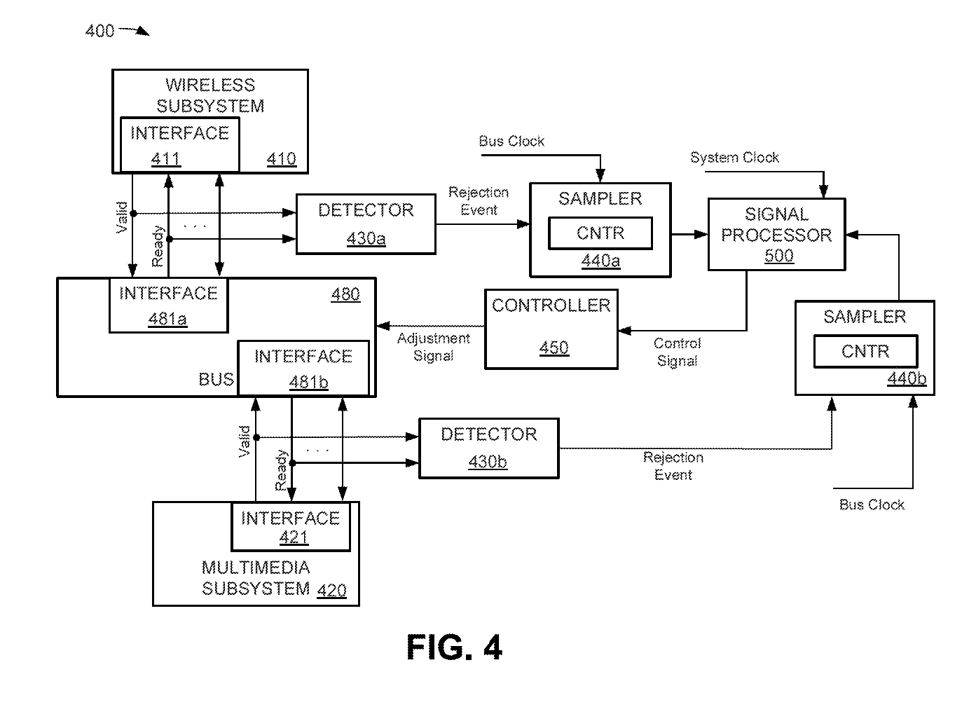

FIG. 4 is an embodiment of the bus controller 390 introduced in FIG. 3. In the illustrated embodiment, the bus controller 390 is a real-time bus monitoring and control system. As illustrated, the real-time bus-monitoring and control system 400 includes a first detector 430a arranged to receive a valid address signal issued by bus interface 411 of a wireless subsystem 410 and a ready signal issued by the interface 481a of the bus 480. More specifically, the detector 430a identifies when the valid address signal is asserted and the ready signal is de-asserted. When this is the case, the detector 430a issues a rejection event pulse that is communicated to the sampler 440a. The sampler 440a uses a bus clock and an integrated counter to generate a sub-sampled representation of the rejection signal, which is forwarded to signal processor 500. The signal processor 500 generates a control signal in response to a system clock that is different than the bus clock. The control signal is communicated to controller 450, which generates an adjustment signal to controllably adjust the clock frequency of a bus 480 of the PCD 320. In some embodiments, the controller 450 may be arranged to adjust a bus voltage.

As further illustrated, the real-time bus-monitoring and control system 400 includes a second detector 430b arranged to receive a valid address signal issued by bus interface 421 of a multimedia subsystem 420 and a ready signal issued by the interface 481b of the bus 480. More specifically, the detector 430b identifies when the valid address signal is asserted and the ready signal is de-asserted. When this is the case, the detector 430b issues a rejection event pulse or rejection signal that is communicated to the sampler 440b. The sampler 440b uses a bus clock and an integrated counter to generate a sub-sampled representation of the rejection signal, which is forwarded to signal processor 500. The signal processor 500 generates a control signal in response to a system clock that is different than the bus clock. The control signal is communicated to controller 450, which generates an adjustment signal to controllably adjust the clock frequency of a bus 480 of the PCD 320. It should be understood that any number of such bus monitoring and feedback circuit arrangements can be deployed as may be desired to optimize power consumption related to the operation of the bus 480 or other buses in PCD 320.

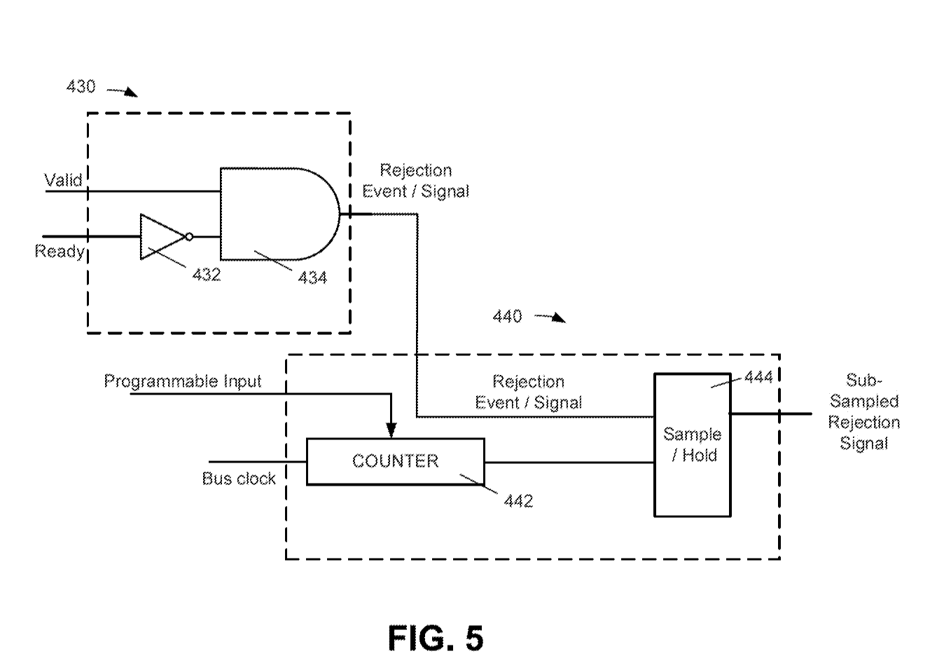

FIG. 5 is a schematic diagram illustrating an embodiment of the detector 430 and an embodiment of the sampler 440 of FIG. 4. In the illustrated embodiment, the detector 430 includes an inverter 432 and an AND gate 434. The inverter 432 receives the ready signal from the bus interface 481 and provides an inverted representation of the ready signal at a first input of the AND gate 434. The valid signal from the bus interface 481 is applied at the remaining input to AND gate 434. Accordingly, the output of the AND gate 434 will produce a pulse when the valid signal is asserted and the ready signal is de-asserted.

As further indicated in FIG. 5, the sampler 440 is implemented with a programmable counter 442. The counter 442 receives a bus clock signal and when enabled by the rejection signal from the detector 430 generates a pulse at its output after N periods of the bus clock. The integer N can be achieved structurally in the counter 442 in a fixed implementation or may be adjustable via a programmable input as shown.

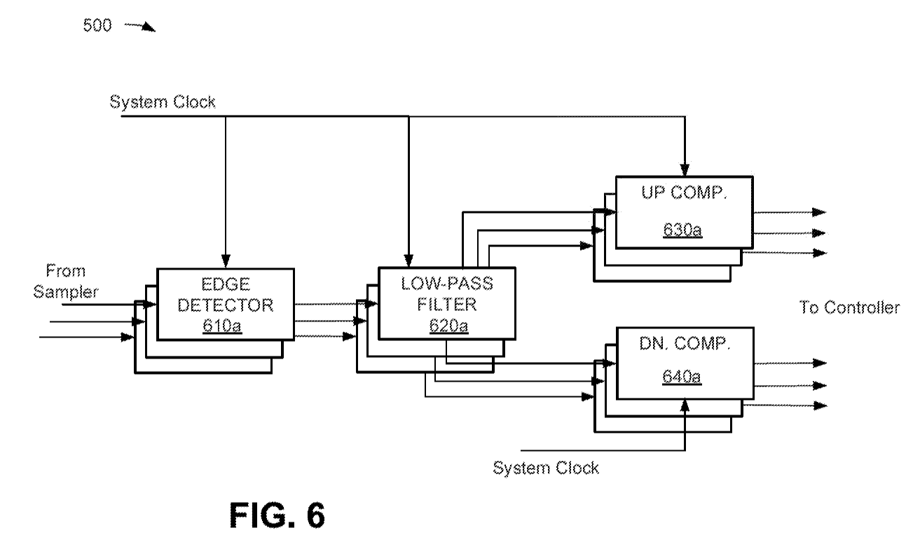

FIG. 6 is a block diagram illustrating an embodiment of the signal processor 500 of FIG. 4. As shown in FIG. 6, the signal processor 500 is responsive to a system clock signal and the sub-sampled rejection signal(s) received from the samplers 440a-440n. The signal processor 500 includes a series arrangement of a set of edge detectors 610a-610n, low-pass filters 620a-620n, “up” comparators 630 and “down” comparators 640. The low-pass filtered versions of the sub-sampled signals are forwarded to respective comparators 630a-630n that generate an “up” control signal when the input signal exceeds the first threshold voltage and a set of respective comparators 640a-640n that generate a “down” control signal when the input signal is below the second threshold voltage. The first threshold voltage and the second threshold voltage may be predetermined and stored in a register (not shown) or in memory 344. Alternatively, the first and second threshold voltages may be programmatically adjusted in accordance with an algorithm stored in the memory 344 and executed in CPU 324.

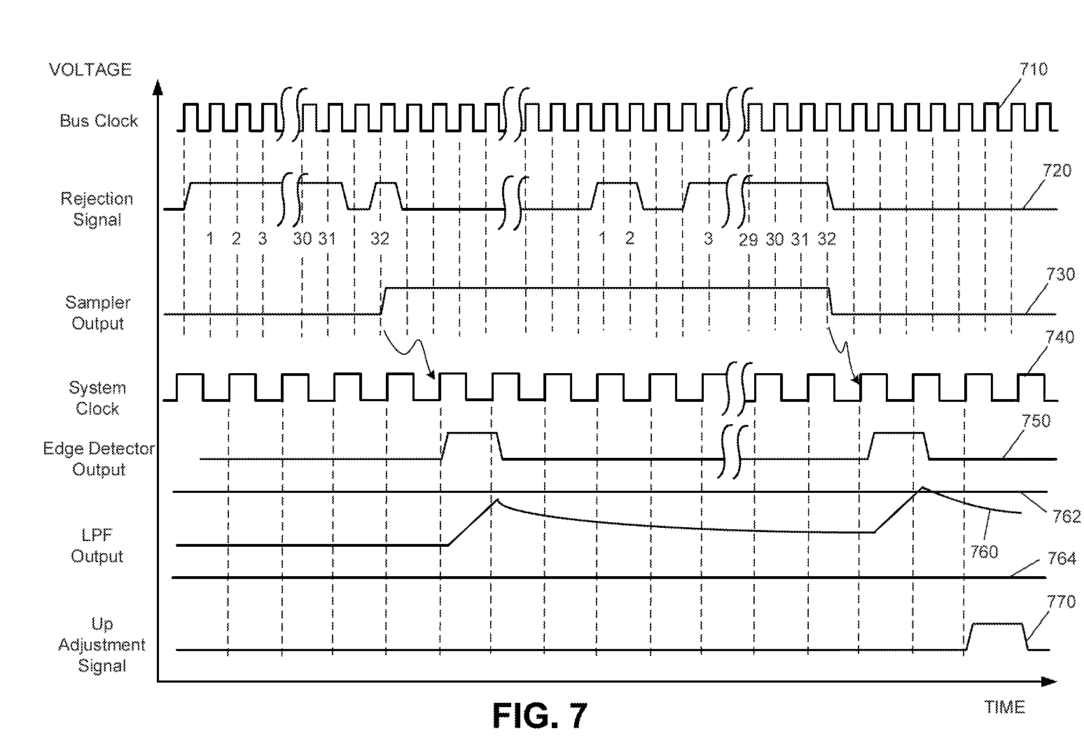

FIG. 7 is a signal timing diagram illustrating relationships between multiple signals within the real-time bus monitoring and control system 400 of FIG. 4. Trace 710 is representative of a bus clock signal operative within bus 480. Trace 720 is representative of an example rejection signal produced by the detector 430.

As indicated above, a rejection event or rejection signal is responsive to a valid address signal issued in a bus interface such as bus interface 481a or bus interface 481b in combination with a de-asserted ready signal in the corresponding bus interface. Trace 730 shows an example sub-sampled output signal as produced by a counter arranged within the sampler 440. As indicated in FIG. 7, the example counter is responsive to 32 bus clock periods. That is, trace 730 indicates that the sampler transitions to the rejection signal voltage and maintains the same voltage for the next 32 bus clock periods. One or more of the sub-sampled versions of the rejection signal are communicated to the signal processor 500.

A system clock signal coupled to the signal processor 500 is represented by trace 740. The system clock signal may be generated by a power management system (not shown) operable within the PCD 320. As indicated above, the system clock signal will preferably have a period that is different from the period of the bus clock signal.

Trace 750 is representative of the output of the edge detector 610 of the signal processor 500. As shown in FIG. 7, the edge detector 610 generates a signal pulse corresponding to the next rising edge of the system clock when both the rejection signal and the sub-sampler output signal simultaneously transition. The output of the edge detector 610 is further processed by the low-pass filer 620, which smooths or reduces ripple in the sub-sampled representation of the rejection signal as shown by trace 760. As further shown in FIG. 7, the low-pass filtered representation of the rejection signal as shown by trace 760 is generally bounded by a first or up threshold voltage 762 and a second or down threshold voltage 764.

As explained, an up adjustment signal, represented by trace 770, is responsive to a comparison of the low-pass filtered signal 760 and the up threshold voltage 762. When the low-pass filtered signal 760 exceeds the first or up threshold voltage 762, the up adjustment signal is generated. Conversely, when the low-pass filtered signal 760 falls below the second or down threshold voltage 764 a down adjustment signal (not shown) is generated. These up and down adjustment signals are forwarded to a frequency synthesizer that produces a bus clock. The frequency synthesizer increases the frequency in a step-wise manner in response to an “up” adjustment signal and decreases the frequency in a step-wise manner in response to a “down” adjustment signal. When a subsequent adjustment signal is the same as a preceding adjustment signal, the controller 450 may be configured to forward a smaller step change to the frequency synthesizer used to generate the bus clock.

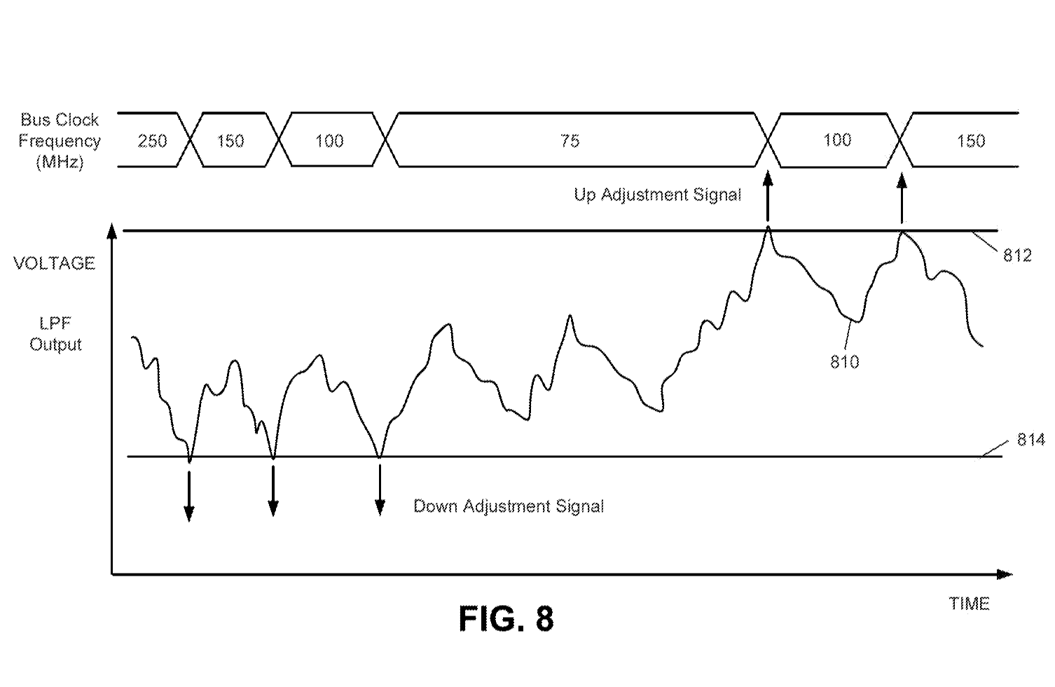

FIG. 8 is a simulation illustrating an example intermediate signal in the real-time bus monitoring and control system 400 of FIG. 4. More specifically, FIG. 8 simulates an example embodiment of trace 810 representing a low-pass filtered representation of the sub-sampled rejection signal bounded by an up threshold 812 and a down threshold 814. As further indicated in the simulation, arrows below the down threshold 814 are indicative of PCD use condition where a downward adjustment signal is generated. Arrows above the up threshold 812 are indicative of a PCD use condition where an upward adjustment signal is generated.

As indicated in FIG. 8, the bus clock frequency changes in accordance with the downward and upward adjustment signals, respectively. In response to the trace 810 meeting or exceeding the down threshold 814, the bus clock frequency is decreased by a first step (frequency). In response to the trace 810 meeting or exceeding the down threshold 814 a second time absent an intervening up adjustment signal, the bus clock frequency is decreased by a second step (frequency) that is different than the first step. In response to the trace 810 meeting or exceeding the down threshold 814 a third time absent an intervening up adjustment signal, the bus clock frequency is decreased by a third step that is different from the first and the second steps. The described method may be repeated until the frequency synthesizer used to generate the bus clock reaches a minimum value.

Thereafter, in response to the trace 810 meeting or exceeding the up threshold 812, the bus clock frequency is increased by a step that is equivalent in magnitude to the last downward step. In response to the trace 810 meeting or exceeding the up threshold 812 a second time absent an intervening down adjustment signal, the bus clock frequency is increased by a second step that is equivalent in magnitude to the second to last downward step. The described method of adjustment may be repeated until the bus clock frequency exceeds a mid-point of the difference between the up threshold 812 and the down threshold 814.

For example, in the illustrated embodiment, the bus clock frequency starts at approximately 250 MHz and in response to a first down adjustment signal is decreased by 100 MHz. In response to a subsequent down adjustment signal the bus clock frequency is decreased by 50 MHz. In response to another down adjustment signal without an intervening up adjustment signal, the bus clock frequency is decreased by 25 MHz to 75 MHz where it remains until the trace 810 exceeds the up threshold 812. As indicated in FIG. 8, the first increase in frequency is by 25 MHz followed by a subsequent upward adjustment of 50 MHz. The example control scheme or other example control schemes may be followed as may be desired.

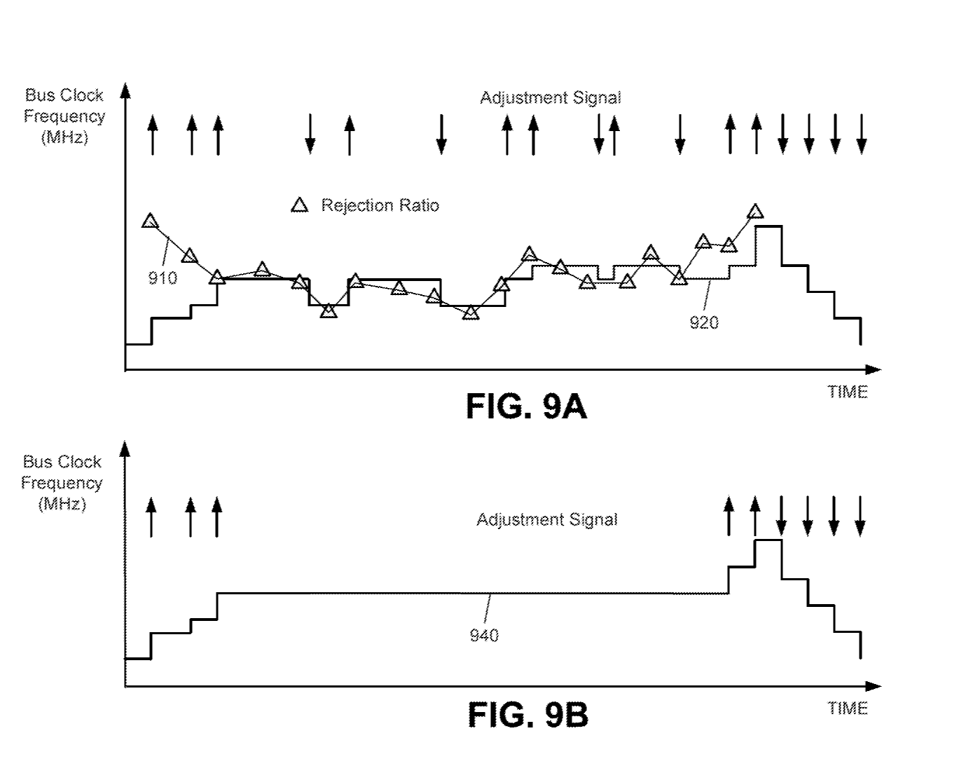

FIGS. 9A and 9B are respective simulations illustrating example bus frequency plots for a bus operating in accordance with the real-time bus monitoring and control system of FIG. 4 under different control parameters. FIG. 9A includes a trace 910 identified by discrete samples generated over time and represented by triangles that shows a rejection ratio. A rejection ratio is determined from the number of detected rejection events that occur over a unit time. A trace 920 showing a corresponding bus clock frequency as adjusted by up and down adjustments over time. FIG. 9B includes a trace 940 showing a bus clock frequency over time for the same PCD use case with a modified downward threshold. That is, the down threshold has been lowered from that applied in the simulation illustrated in FIG. 9A. As a result, the bus frequency is adjusted less frequently in the simulation illustrated in FIG. 9B when compared to the simulation illustrated in FIG. 9A.

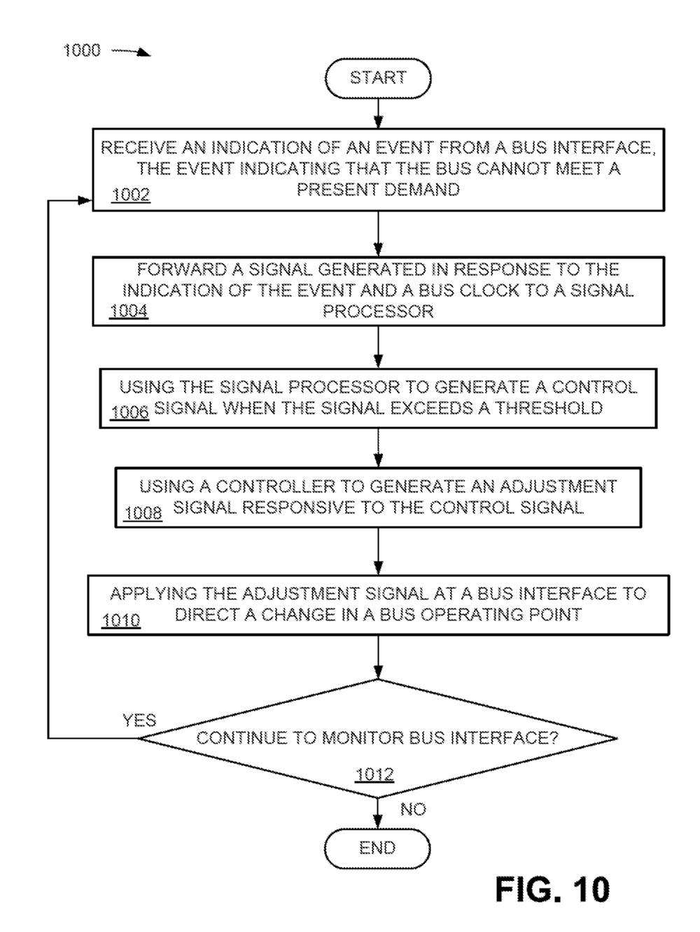

FIG. 10 is a flowchart illustrating an example embodiment of a method 1000 for controlling a bus in response to a real-time indication of bus capacity in PCD 320. The method 1000 begins with block 1002 where an indication of an event from a bus interface is received. As indicated in block 1002, the event is indicative of circumstances that render the bus incapable of meeting a present demand by a processing resource coupled to the bus. In block 1004, a signal generated in response to the indication of the event and a bus clock is communicated to the signal processor 500. As shown in block 1006, the signal processor 500 generates a control signal when the signal exceeds a threshold. As described, the control signal generated by signal processor 500 will indicate that the bus clock frequency should be increased or decreased. As illustrated in block 1008, the controller 450 generates an appropriate adjustment signal in response to the control signal. In turn, as shown in block 1010, the adjustment signal, as applied at a bus interface, directs the bus 480 to change a bus operating point. As shown in decision block 1012, a determination is made whether to continue to monitor the bus interface. When it is desired to monitor the bus interface, as indicated by the flow control arrow labeled, “Yes” the method returns to block 1002. Alternatively, when it is no longer desired to monitor the bus interface, the method 1000 is terminated.

As indicated above, the method 1000 can be applied by detector 430, sampler 440, signal processor 500 and controller 450 to controllably adjust the clock frequency of a bus 480 of the PCD 320. When the bus operating point is unable to provide a bus ready signal to the requesting processing resource (e.g., wireless subsystem 410), as identified by a rejection event ratio in excess of a desired threshold, the controller 450 increases the bus clock until the detector 430 no longer indicates that rejection events are occurring at or above the threshold in the bus interface or until the maximum bus clock frequency is reached. Conversely, when the bus operating point is more than capable to meet present data transfer loads, as indicated by the occurrence of rejection events that is below a desired threshold, the controller 450 decreases the bus clock frequency. These downward adjustments will continue until data demands increase as indicated in the bus interface or a minimum bus clock frequency is reached. In this manner, power consumption within the bus 480 is controllably adjusted to a level that supports the real-time use of the PCD 320.

Certain steps in the processes or process flows described in this specification naturally precede others for the invention to function as described. However, the invention is not limited to the order of the steps described if such order or sequence does not alter the functionality of the invention. That is, it is recognized that some steps may performed before, after, or in parallel (substantially simultaneously) with other steps without departing from the scope of the invention. In some instances, certain steps may be omitted or not performed without departing from the invention. Further, words such as “thereafter”, “then”, “next”, “subsequently”, etc. are not intended to limit the order of the steps. These words are simply used to guide the reader through the description of the exemplary method.

Additionally, one of ordinary skill in programming is able to write computer code or identify appropriate hardware and/or circuits to implement the disclosed invention without difficulty based on the flow charts and associated description in this specification, for example. Therefore, disclosure of a particular set of program code instructions or detailed hardware devices is not considered necessary for an adequate understanding of how to make and use the invention. The inventive functionality of the claimed processor-enabled processes is explained in more detail in the above description and in conjunction with the drawings, which may illustrate various process flows.

In one or more exemplary aspects as indicated above, the functions described may be implemented in hardware, software, firmware, or any combination thereof. If implemented in software, the functions may be stored on or transmitted as one or more instructions or code on a computer-readable medium, such as a non-transitory processor-readable medium. Computer-readable media include both data storage media and communication media including any medium that facilitates transfer of a program from one location to another.

A storage media may be any available media that may be accessed by a computer or a processor. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of non-transitory computer-readable media.

Although selected aspects have been illustrated and described in detail, it will be understood that various substitutions and alterations may be made herein without departing from the present invention, as defined by the following claims.

What is claimed is:

1. A method for controlling a bus in response to a real-time indication of bus capacity in a portable computing device, the method comprising:
receiving an indication of an event from an interface of the bus, the event indicating that the bus is incapable of achieving a present demand;
forwarding, from a sampler, a signal generated in response to the indication of the event and a bus clock;
receiving the signal at an input of a signal processor, the signal processor generating a control signal when the signal exceeds a threshold;
receiving the control signal at a controller that generates an adjustment signal; and
applying the adjustment signal to the bus to direct a change in a bus operating point.

2. The method of claim 1, wherein the indication of the event is responsive to a state of the interface between a processing resource and the bus.

3. The method of claim 2, wherein the state is identified by a combination of a valid address signal asserted by the processing resource and a de-asserted ready signal from the bus.

4. The method of claim 2, wherein the processing resource is selected from a group consisting of a multimedia subsystem, a peripheral subsystem, a modem subsystem, an application subsystem, a memory subsystem, an audio subsystem, and a wireless connectivity subsystem.

5. The method of claim 4, wherein the bus provides interconnectivity between a first processing resource and a second processing resource.

6. The method of claim 3, wherein a detector identifies a rejection event in response to the valid address signal and the de-asserted ready signal.

7. The method of claim 1, wherein the sampler includes a counter arranged to sub-sample the indication of the event.

8. The method of claim 1, wherein the signal processor includes an edge detector, a low-pass filter, a first comparator and a second comparator.

9. The method of claim 1, wherein the adjustment signal directs the bus to modify a frequency of a bus clock signal.

10. The method of claim 1, wherein the adjustment signal directs the bus to modify a voltage of a data signal in the bus.

11. A portable computing device, comprising:
a processing resource communicatively coupled to a bus via a bus interface;
a detector responsive to signal conditions at the bus interface, the detector arranged to identify when the bus is incapable of achieving a present demand by generating a rejection signal;
a sampler coupled to the detector, the sampler arranged to generate a modified signal in response to the rejection signal and a bus clock;
a signal processor coupled to the sampler, the signal processor arranged to generate a control signal when the modified signal exceeds a threshold; and
a controller coupled to the signal processor, the controller arranged to generate an adjustment signal that directs the bus to change a present operating point.

12. The portable computing device of claim 11, wherein the detector is responsive to a state on the bus interface.

13. The portable computing device of claim 12, wherein the state is identified by a combination of a valid address signal asserted by the processing resource and a de-asserted ready signal from the bus.

14. The portable computing device of claim 11, wherein the processing resource is selected from a group consisting of a multimedia subsystem, a peripheral subsystem, a modem subsystem, an application subsystem, a memory subsystem, an audio subsystem, and a wireless connectivity subsystem.

15. The portable computing device of claim 14, wherein the bus provides interconnectivity between a first processing resource and a second processing resource.

16. The portable computing device of claim 11, wherein the sampler includes a counter arranged to sub-sample the rejection signal.

17. The portable computing device of claim 11, wherein the signal processor includes an edge detector, a low-pass filter, a first comparator and a second comparator.

18. The portable computing device of claim 17, wherein the low-pass filter, the first comparator and the second comparator are programmable.

19. The portable computing device of claim 18, wherein the low-pass filter is adjusted by manipulating a switch to modify a capacitance or a resistance.

20. The portable computing device of claim 17, wherein the first comparator receives a first threshold and an output of the low-pass filter and the second comparator receives a second threshold different from the first threshold and the output of the low-pass filter.

21. The portable computing device of claim 11, wherein the adjustment signal directs the bus to modify a frequency of the bus clock.

22. The portable computing device of claim 11, wherein the adjustment signal directs the bus to modify a voltage of a data signal in the bus.

23. A portable computing device, comprising:
means for identifying an event in an interface that communicatively couples a processing resource to a bus;
means for receiving an indication of an occurrence of the event;
means for modifying the indication of the occurrence of the event;
means for comparing a result generated by the means for modifying the indication of the occurrence of the event to generate a control signal; and
means for applying the control signal to generate an adjustment signal that directs the bus to modify a bus operating point.

24. The portable computing device of claim 23, wherein the means for identifying the event in the interface includes a detector comprising logic gates.

25. The portable computing device of claim 24, wherein the detector identifies a combination of a valid address signal asserted by the processing resource and a de-asserted ready signal from the bus.

26. The portable computing device of claim 23, wherein the processing resource is selected from a group consisting of a multimedia subsystem, a peripheral subsystem, a modem subsystem, an application subsystem, a memory subsystem, an audio subsystem, and a wireless connectivity subsystem.

27. The portable computing device of claim 26, wherein the bus provides interconnectivity between a first processing resource and a second processing resource.

28. The portable computing device of claim 23, wherein the means for receiving the indication of the occurrence of the event includes a sampler responsive to a bus clock.

29. The portable computing device of claim 23, wherein the means for modifying the indication of the occurrence of the event includes a signal processor.

30. The portable computing device of claim 29, wherein the signal processor includes an edge detector and a low-pass filter.

31. The portable computing device of claim 30, wherein the low-pass filter is programmable.

32. The portable computing device of claim 23, wherein the means for comparing the result includes at least one comparator.

33. The portable computing device of claim 32, wherein the means for comparing includes a first comparator that receives a first threshold and an output of a low-pass filter and a second comparator that receives a second threshold and the output of the low-pass filter.

34. The portable computing device of claim 23, wherein the adjustment signal directs the bus to modify a frequency of a bus clock.

35. The portable computing device of claim 23, wherein the adjustment signal directs the bus to modify a voltage of a data signal in the bus.

36. A non-transitory processor-readable medium having stored thereon processor instructions that direct the processor to perform functions, comprising:
receiving an indication of an event from an interface of a bus, the event indicating that the bus is incapable of achieving a present demand;
sub-sampling the indication of the event from the interface in accordance with a function of a frequency of a bus clock to generate a sub-sampled signal;
processing the sub-sampled signal by detecting an edge of the sub-sampled signal to generate a representation of the sub-sampled signal;
applying a low-pass filter to the representation of the sub-sampled signal to generate a filtered representation of the sub-sampled signal;
comparing the filtered representation of the sub-sampled signal with a first threshold and a second threshold;
generating a first control signal when the comparing indicates that the filtered representation of the sub-sampled signal exceeds the first threshold;
generating a second control signal when the comparing indicates that the filtered representation of the sub-sampled signal is below the second threshold;
generating an adjustment signal in response to the first control signal and the second control signal; and
communicating the adjustment signal to the bus.

37. The non-transitory processor-readable medium of claim 36, wherein the event is responsive to a state of the interface between a processing resource and the bus.

38. The non-transitory processor-readable medium of claim 37, wherein the state is identified by a combination of a valid address signal asserted by the processing resource and a de-asserted ready signal from the bus.

39. The non-transitory processor-readable medium of claim 37, wherein the processing resource is selected from a group consisting of a multimedia subsystem, a peripheral subsystem, a modem subsystem, an application subsystem, a memory subsystem, an audio subsystem, and a wireless connectivity subsystem.

40. The non-transitory processor-readable medium of claim 39, wherein the bus provides interconnectivity between a first processing resource and a second processing resource.

41. The non-transitory processor-readable medium of claim 36, wherein the sub-sampled signal is responsive to a bus clock signal.

42. The non-transitory processor-readable medium of claim 36, wherein at least one of the applying the low-pass filter to the representation of the sub-sampled signal and the comparing the filtered representation of the sub-sampled signal with the first threshold and with the second threshold is responsive to a signal generated for managing power consumption.

43. The non-transitory processor-readable medium of claim 36, wherein the adjustment signal directs the bus to modify the frequency of the bus clock.

44. The non-transitory processor-readable medium of claim 36, wherein the adjustment signal directs the bus to modify a voltage of a data signal in the bus.
